(19) United States
(12) Patent Application Publication
(10) Pub. No.: US 2010/0151258 A1
(43) Pub. Date: Jun. 17, 2010

(54) Coating method of automobile body

(76) Inventor: Koji Okuma, Takahama-shi (JP)

Correspondence Address: KUBOVCIK & KUBOVCIK, SUITE 1105, 1215 SOUTH CLARK STREET, ARLINGTON, VA, 22202, US

(21) Appl. No.: 12/458,908

(22) Filed: Jul. 27, 2009

(30) Foreign Application Priority Data
Jul. 28, 2008 (JP) 193518/2008

(51) Int. Cl. B32B 9/00; B05D 3/02; B32B 19/00

(52) U.S. Cl. 428/448; 427/372.2; 427/397.7; 428/702

(57) ABSTRACT

Method for forming multilayer coating on an electrodeposition coating of an outer plate part (“OPP”), an inner plate part (“IPP”) and boundary part (“BP”) between the IPP and OPP of an automobile body, including forming a first multilayer-coating on the OPP by coating white intermediate paint (1) (N7 to N9.5) on an electrodeposition coating, coating thereon, by a wet-on-wet technique, white base paint (2) (N7 to N9.5), luster pigment-containing paint (3), and clear paint (4), and then baking; and carrying out at least one of (A) and (B) and thereafter (C) on an IPP and BP (“IPP/BP”), (A) coating (1) in the IPP/BP, prior to (1) in the OPP, (B) coating (2) in the IPP/BP, prior to (2) in the OPP, and (C) coating luster material-containing clear paint (5) in the IPP/BP, prior to (4) in the OPP; wherein the second IPP/BP multilayer-coating is baked simultaneously with the first multilayer-coating.

### BACKGROUND OF THE INVENTION

1. Field of the Invention

The present invention relates to a coating method of an automobile body for forming a multilayer coating film on an electrodeposition coating film layer of an outer plate part, an inner plate part and a boundary part between the inner plate part and the outer plate part of an automobile body.

2. Description of the Related Art

In general, in coating an automobile body, after forming an electrodeposition coating film layer by electrodeposition coating, intermediate coating is applied thereon, and after baking this intermediate coating film for hardening, top coating is applied.

In case of top coating in which a luster pigment, for example, an aluminum flake, a mica powder, etc. is blended, in many cases, coating is carried out by a 3-coat 1-bake system in which a base paint is coated on an intermediate coating film; a luster material-containing base paint having a luster pigment incorporated thereinto is coated thereon; a clear paint is further coated thereon; and these three layers are baked at once.

In coating an automobile body, in general, an outer plate part is coated by a coating machine, and an inner plate part having a complicated surface shape and a boundary part between the inner plate part and the outer plate part are coated by a person, a robot or the like.

FIG. 5 is a plan view showing an example of a general coating line of an automobile body in case of coating by a 3-coat 1-bake system and is a view of the coating line seen from an upper direction. An automobile body is coated while being conveyed from left to right in the drawing and sent to a baking furnace for baking a coating film.

As the coating machine, a first-stage coating machine 1, a second-stage coating machine 2 and a third-stage coating machine 3 are disposed in this order from the left. As to the coating machine, plural machines are in general set up in each of the areas.

A working area 4 is provided before the first-stage coating machine 1. The working area 4 is, for example, a space for coating an inner plate part located on the inside of the automobile body and a boundary part between the inner plate part and an outer plate part, and as described previously, the inner plate part and the boundary part of an automobile body are coated by a person, a robot or the like.

A working area 5 is also provided between the first-stage coating machine 1 and the second-stage coating machine 2, and in the working area 5, the inner plate part and the boundary part of the automobile body can be coated by a person, a robot or the like, too.

Similarly, a working area 6 is also provided between the second-stage coating machine 2 and the third-stage coating machine 3, and in the working area 6, the inner plate part and the boundary part of the automobile body can be coated by a person, a robot or the like, too.

In the coating line shown in FIG. 5, in case of coating a base paint, a luster material-containing base paint and a clear paint by a 3-coat 1-bake system, first of all, in the working area 4, the base paint is coated in the inner plate part and the boundary part of the automobile body, and subsequently, the base paint is coated in the outer plate part of the automobile body by the coating machine 1.

Subsequently, in the working area 5, the luster material-containing base paint is coated in the inner plate part and the boundary part of the automobile body, and the luster material-containing base paint is then coated in the outer plate part of the automobile body by the coating machine 2.

Subsequently, in the working area 6, the clear paint is coated in the inner plate part and the boundary part of the automobile body, and the clear paint is then coated in the outer plate part of the automobile body by the coating machine 3.

The base paint, the luster material-containing base paint and the clear paint are thus coated in the outer plate part, the inner plate part and the boundary part of the automobile body and then sent to a baking furnace, thereby baking the respective coating films for hardening.

Now, in recent years, for the purposes of further reducing consumed energy and simplifying a process of manufacture, it is proposed to achieve coating by a 4-coat 1-bake system as a whole by coating an intermediate coating layer on an electrodeposition coating film layer by means of a wet-on-wet technique and applying coating thereon by the conventional 3-coat 1-bake system (see, for example, JP-A-2004-298837).

It is unreasonable to achieve coating by such a 4-coat 1-bake system by the coating line shown in FIG. 5. For example, it is necessary to consider a method in which the second-stage coating machine 2 is divided into a coating machine 2a of the preceding stage and a coating machine 2b of the subsequent stage, the base paint is coated by the coating machine 2a of the preceding stage, and the luster material-containing base paint is coated by the coating machine 2b of the subsequent stage or other methods.

However, in such case, there is involved a problem that in any one of the working area 5 or the working area 6, the inner plate part and the boundary part of the automobile body must be coated twice. The working area 5 and the working area 6 are spatially restricted, and therefore, there is involved a problem that when two kinds of coating are applied, a process of working is complicated. Also, since it is necessary to apply the second coating immediately after the first coating, there is involved a problem that a disturbance is easily generated on the coating film interface so that a good appearance of the coating film is not obtained.

JP-A-10-272415 discloses a coating method of an inner plate part and a boundary part of an automobile body in case of applying coating in an outer plate part of the automobile body by a 3-coat 1-bake system but does not describe at all coating by a 4-coat 1-bake system.

### SUMMARY OF THE INVENTION

An object of the invention is to provide a coating method of an automobile body in which in case of coating an outer plate part of an automobile body, a coating film having an appearance close to an appearance of a coating film of an outer plate part can be formed in an inner plate part and a boundary part by a 2-coat 1-bake system or a 3-coat 1-bake system; and an automobile body coated by the subject coating method.

The invention is concerned with a coating method of an automobile body for forming a multilayer coating film on an electrodeposition coating film layer of an outer plate part, an inner plate part and a boundary part between the inner plate part and the outer plate part of an automobile body, which comprises coating an outer plate part of an automobile body by a 4-coat 1-bake system including coating a white based intermediate paint (1) with from N7 to N9.5 on an electrodeposition coating film layer, coating a white based color base paint (2) with from N7 to N9.5 thereon by a wet-on-wet technique, coating a luster material-containing base paint (3) containing a luster pigment thereon by a wet-on-wet technique, further coating a clear paint (4) thereon by a wet-on-wet technique, and then baking for hardening a first multilayer coating film in the outer plate part of the automobile body; and carrying out at least one step of steps (A) and (B) and thereafter carrying out a step (C) with respect to an inner plate part and a boundary part of the automobile body, the step (A) including coating the white based intermediate paint (1) in the inner plate part and the boundary part of the automobile body, prior to coating the white based intermediate paint (1) in the outer plate part of the automobile body, the step (B) including coating the white based color base paint (2) in the inner plate part and the boundary part of the automobile body, prior to coating the white based color base paint (2) in the outer plate part of the automobile body, and the step (C) including coating a luster material-containing clear paint (5) corresponding to a paint containing the luster pigment dispersed in the clear paint (4) in the inner plate part and the boundary part of the automobile body, prior to coating the clear paint (4) in the outer plate part of the automobile body; wherein a second multilayer coating film in the inner plate part and the boundary part of the automobile body is baked simultaneously with baking of the first multilayer coating film in the outer part of the automobile body.

In the invention, as described previously, after carrying out at least one step of the following steps (A) and (B), the following step (C) is carried out.

Step (A): A step of, prior to coating a white based intermediate paint (1) in an outer plate part of an automobile body, coating the white based intermediate paint (1) in an inner plate part and a boundary part of the automobile body.

Step (B): A step of, prior to coating a white based color base pain (2) in the outer plate part of the automobile body, coating the white based color base paint (2) in the inner plate part and the boundary part of the automobile body.

Step (C): A step of, prior to coating a clear paint (4) in the outer plate part of the automobile body, coating a luster material-containing clear paint (5) corresponding to a paint having a luster pigment incorporated in the clear paint (4) in the inner plate part and the boundary part of the automobile body.

In consequence, according to the invention, a multilayer coating film can be formed in an inner plate part and a boundary part of an automobile body by the following first embodiment, second embodiment and third embodiment.

That is, in the first embodiment, after the step (A), the step (C) is carried out, thereby forming the multilayer coating film of the inner plate part and the boundary part of the automobile body from the white based intermediate paint (1) and the luster material-containing clear paint (5).

In the second embodiment, after the step (B), the step (C) is carried out, thereby forming the multilayer coating film of the inner plate part and the boundary part of the automobile body from the white based color base paint (2) and the luster material-containing clear paint (5).

In the third embodiment, after the step (A) and the step (B), the step (C) is carried out, thereby forming the multilayer coating film of the inner plate part and the boundary part of the automobile body from the white based intermediate paint (1), the white based color base paint (2) and the luster material-containing clear paint (5).

According to the invention, in case of coating an outer plate part of an automobile body by a 4-coat 1-bake system, a coating film having an appearance close to an appearance of a coating film of an outer plate part can be formed in an inner plate part and a boundary part by a 2-coat 1-bake system or a 3-coat 1-bake system. In consequence, the outer plate part of the automobile body can be coated by a 4-coat 1-bake system by using an existing coating line, and a coating film having an appearance close to an appearance of the coating film of the outer plate part can be formed in the inner plate part and the boundary part of the automobile body.

The white based intermediate paint (1), the white based color base paint (2), the luster material-containing base paint (3), the clear paint (4) and the luster material-containing clear paint (5) to be used in the invention are hereunder described.

### <White Based Intermediate Paint (1)>

In the invention, the white based intermediate paint (1) has a value of from N7 to N9.5 in terms of a Munsell value. In such a white based intermediate paint, a white based pigment such as titanium dioxide is incorporated thereinto, thereby regulating its Munsell value so as to fall within the foregoing range.

As the white based intermediate paint (1), an aqueous intermediate paint is preferably used. Examples of a resin component of the aqueous intermediate paint include (a) a water-dispersible vinyl-modified polyester resin and (b) a water-soluble epoxy-modified polyester resin.

The water-dispersible vinyl-modified polyester resin (a) which is used in the invention is a water-dispersible polyester resin having a fatty acid chain having a vinyl polymer segment bonded thereto. For example, the foregoing water-dispersible vinyl-modified polyester resin (a) can be produced by a method for condensing a vinyl-modified fatty acid having a vinyl polymer segment, which is obtained by radical polymerizing a carboxyl group-containing α,β-ethylenically unsaturated monomer and other copolymerizable α,β-ethylenically unsaturated monomer in the presence of an unsaturated fatty acid, and a hydroxyl group-containing polyester resin.

An acid value of the water-dispersible vinyl-modified polyester resin (a) is preferably from 20 to 100 mg-KOH/g. Also, in the water-dispersible vinyl-modified polyester resin (a), it is preferable that the vinyl polymer segment accounts for from 15 to 45% by mass.

A weight average molecular weight of the water-dispersible vinyl-modified polyester resin (a) is preferably in the range of from 10,000 to 150,000. The weight average molecular weight is a value obtained by reducing a measured value by a gel permeation chromatography (GPC) method into a polystyrene standard.

The water-soluble epoxy-modified polyester resin (b) which is used in the invention is an epoxy group-containing water-soluble polyester resin. The water-soluble epoxy-modified polyester resin (b) is obtained by modifying a polyester resin having two or more hydroxyl groups in one molecule thereof with an epoxy resin. For example, reactions such as addition, condensation and grafting are employable. Specific examples thereof include a reaction of an epoxy group of an epoxy resin and a carboxyl group or a hydroxyl group of a polyester resin; and a reaction of, in using a polyisocyanate compound, the subject compound with an epoxy resin and a hydroxyl group of a polyester resin.

A weight average molecular weight of the water-soluble epoxy-modified polyester resin (b) is preferably in the range of from 5,000 to 30,000.

Also, a hydroxyl value is preferably in the range of from 75 to 200 mg-KOH/g. An acid value is preferably in the range of from 25 to 50 mg-KOH/g.

The aqueous intermediate paint may be one in combination with other polymer such as a polyester resin and an acrylic resin.

The aqueous intermediate paint is one further containing a hardening agent. The hardening agent is not particularly limited so far as it is able to cause a hardening reaction with the foregoing resin component and be blended in an aqueous paint composition. Examples thereof include a melamine resin and an isocyanate resin.

As the pigment which is incorporated into the aqueous intermediate paint, in addition to the foregoing white based pigment, filler pigments such as clay, talc, kaolin and barium sulfate and other pigments can be used. A pigment weight concentration (PWC) of the pigment in the aqueous intermediate paint is preferably in the range of from 10 to 60%.

The aqueous intermediate paint is not particularly limited so far as it is aqueous, and examples thereof include a water-soluble form, a water-dispersible form and an aqueous emulsion form.

### <White Based Color Base Paint (2)>

In the invention, the white based color base paint (2) is one having a value in the range of from N7 to N9.5 in terms of a Munsell value. Similar to the foregoing white based intermediate paint (1), such a white color base paint can be prepared by incorporating a white based pigment such as titanium dioxide thereinto.

In the invention, the white based color base paint (2) is preferably an aqueous base paint.

Examples of a resin component of the white based color base paint include an acrylic resin, a polyester resin, an alkyd resin and a fluorocarbon resin. Also, examples of a hardening agent include a melamine resin and an isocyanate resin.

A content of the resin component and the hardening agent in the paint is preferably in the range of from 30 to 70% by mass.

Similar to the foregoing white based intermediate paint (1), in addition to the white based pigment, an filler pigment and other pigment can be incorporated as the pigment. A pigment weight concentration (PWC) in the paint is preferably in the range of from 3 to 70%.

The aqueous base paint is not particularly limited so far as it is aqueous, and examples thereof include a water-soluble form, a water-dispersible form and an aqueous emulsion form.

### <Luster Material-Containing Base Paint (3)>

As a resin component and a hardening agent of the luster material-containing base paint (3), those described as the resin component and the hardening agent of the foregoing white based color base paint (2) can be used. Also, as to their content, the same range of the content is applicable.

As the luster pigment which is incorporated into the luster material-containing base paint (3), those used in usual metallic paints can be used. Examples of a substrate of the foregoing pigment include a mica powder (mica or synthetic mica), an alumina powder and a silica powder. Examples of the mica powder include an interference mica pigment, a colored mica pigment and a white mica pigment. Each of the interference mica pigment, the colored mica pigment and the white mica pigment may be a mica pigment, the surface of which is coated with a metal oxide such as TiO₂, SnO₂, ZrO₂, Fe₂O₃, ZnO₂, Cr₂O₃, V₂O₅ and hydrates thereof.

The alumina powder is an oxide of aluminum, and examples thereof include a flaky luster pigment which is coated with the foregoing metal oxide.

As the silica powder, there is exemplified flaky silicon dioxide which is coated with the foregoing metal oxide.

The luster material-containing base paint (3) may contain other pigment in addition to the luster pigment.

A pigment weight concentration (PWC) in the luster material-containing base paint (3) is preferably from 0.1 to 50%, more preferably from 0.5 to 40%, and especially preferably from 1.0 to 30%.

### <Clear Paint (4)>

Examples of a resin component of the clear resin (4) include an acrylic resin, a polyester resin, an epoxy resin and an urethane resin. Examples of a hardening system of the clear resin (4) include a combination of an acrylic resin and/or a polyester resin and an amino resin; and an acrylic resin and/or a polyester resin having a carboxylic acid/epoxy hardening system.

A content of solids in the clear paint (4) is preferably from 20 to 60% by mass.

As a paint form of the clear paint (4) which is used in the invention, any of an organic solvent type, an aqueous type (which is a water-soluble, water-dispersible or emulsion type), a non-aqueous dispersion type or a powder type. If desired, a hardening catalyst, a surface conditioner and the like can be used.

### <Luster Material-Containing Clear Paint (5)>

The luster material-containing clear paint (5) which is used in the invention is a paint corresponding to a paint in which the luster pigment to be incorporated into the luster material-containing base paint (3) is incorporated into the clear paint (4). In consequence, the luster material-containing clear paint (5) can be prepared by adding and mixing the luster pigment incorporated into the luster material-containing base paint (3) in the clear paint (4).

However, it is not always required to use the clear paint (4), but other kind of a clear paint can be used so far as the clear paint assumes an appearance of the same degree as in the clear coating film which is obtained by coating the clear paint (4). Also, it is not always required to use the luster pigment incorporated into the luster material-containing base paint (3), but other luster pigment may be used.

Also, in the luster material-containing base paint (3), in case of incorporating other pigment than the luster pigment, other pigment than the luster pigment may be incorporated into the luster material-containing clear paint (5).

A pigment weight concentration (PWC) in the luster material-containing clear paint (5) is preferably from 0.1 to 5%, more preferably from 0.3 to 3%, and especially preferably from 0.5 to 2%.

### <Coating Method>

In the invention, though a method for coating the outer plate part of the automobile body is not particularly limited, for example, air electrostatic spraying, rotary atomization type electrostatic coating, etc. can be adopted.

Also, in the invention, though a method for coating the inner plate part and the boundary part is not particularly limited, examples of the coating method which can be adopted include manual spray coating, for example, spray coating by a person, a robot or the like, etc.

After coating an aqueous paint, it is preferred to carry out preheating or the like. Examples of a condition of preheating include a condition at a temperature of from room temperature to 100° C. for from 30 seconds to 15 minutes.

In the invention, as to baking of the multilayer coating film of the outer plate part of the automobile body and baking of the multilayer coating film of the inner plate part and the boundary part of the automobile body, baking can be carried out at a temperature which is properly chosen depending upon the paint to be used. For example, baking for hardening can be carried out at a temperature falling within the range of from 110° C. to 180° C. Also, a baking time can be made to fall within the range of, for example, from 10 to 60 minutes.

In the invention, as the electrodeposition coating film layer, one which is generally formed as an undercoat coating film on an automobile body can be used. The electrodeposition coating film can be, for example, formed of a cationic electrodeposition paint.

In the invention, a thickness of the white based intermediate coating film formed of the white based intermediate paint (1) is in the range of, for example, from 10 to 40 μm. Also, a thickness of the white based color base coating film formed of the white based color base paint (2) is in the range of, for example, from 5 to 30 μm.

Also, a thickness of the luster material-containing base coating film formed by coating the luster material-containing base paint (3) is, for example, from 10 to 30 μm. Also, a thickness of the clear coating film formed by coating the clear paint (4) is in the range of, for example, from 10 to 70 μm. Also, a thickness of the luster material-containing clear coating film formed by coating the luster material-containing clear paint (5) is in the range of, for example, from 10 to 70 μm.

The automobile body of the invention is an automobile body which is characterized by being coated by the foregoing coating method of the invention.

According to the invention, in case of coating the outer plate part of the automobile body by a 4-coat 1-bake system, a coating film having an appearance close to an appearance of the coating film of the outer plate part can be formed in the inner plate part and the boundary part by a 2-coat 1-bake system or a 3-coat 1-bake system. In consequence, according to the invention, the outer plate part of the automobile body can be coated by a 4-coat 1-bake system while using an existing coating line. Also, a coating film having an appearance close to an appearance of the coating film of the outer plate part can be efficiently formed in the inner plate part and the boundary part of the automobile body.

### BRIEF DESCRIPTION OF THE DRAWINGS

FIG. 1 is a schematic sectional view showing the state of a multilayer coating film in an outer plate part, an inner plate part and a boundary part of an automobile body of an embodiment according to the invention.

FIG. 2 is a schematic sectional view showing the state of a multilayer coating film in an outer plate part, an inner plate part and a boundary part of an automobile body in the Comparative Examples.

FIG. 3 is a sectional view showing a multilayer coating film in Examples 2 and 3 according to the invention.

FIG. 4 is a sectional view showing a multilayer coating film in Example 1 according to the invention.

FIG. 5 is a plan view showing a coating line of an automobile body which is used for coating by a 3-coat 1-bake system.

### DESCRIPTION OF THE PREFERRED EMBODIMENTS

The invention is hereunder described with references to specific embodiments and working examples, but it should not be construed that the invention is limited to the following embodiments and working examples.

An embodiment of the coating method according to the invention is described with reference to FIG. 5.

An automobile body in which after a chemical conversion treatment, an electrodeposition coating film layer is formed by electrodeposition coating is conveyed into the coating process line shown in FIG. 5.

In the working area 4, the white based intermediate paint (1) is coated in an inner plate part and a boundary part of an automobile body by a person, a robot or the like. Also, in the working area 5, the white based color base paint (2) is coated in the inner plate part and the boundary part of the automobile body by a person, a robot or the like. In the invention, coating is carried out in at least one of the working area 4 and the working area 5.

In the first embodiment according to the invention, coating is carried out in the working area 4, whereas coating is not carried out in the working area 5.

In the second embodiment according to the invention, coating is not carried out in the working area 4, whereas coating is carried out in the working area 5.

In the third embodiment according to the invention, coating is carried out in both the working area 4 and the working area 5.

In the first embodiment according to the invention, in the working area 4, the white based intermediate paint (1) is coated in the inner plate part and the boundary part of the automobile body having an electrodeposition coating film layer formed thereon.

Subsequently, the white based intermediate paint (1) is coated in the outer plate part of the automobile body having an electrodeposition coating film layer formed thereon by the first-stage coating machine 1.

Subsequently, in the working area 5, coating is not carried out, and the white based color base paint (2) is coated in the outer plate part of the automobile body by the coating machine 2a of the preceding stage in the second-stage coating machine 2.

Subsequently, the luster material-containing base paint (3) is coated by the coating machine 2b of the subsequent stage in the second-stage coating machine 2.

Subsequently, in the working area 6, the luster material-containing clear paint (5) is coated in the inner plate part and the boundary part of the automobile body by a person, a robot or the like.

Subsequently, the clear paint (4) is coated in the outer plate part of the automobile body by the third-stage coating machine 3.

The automobile body in which the multilayer coating film has been thus formed in the outer plate part, the inner plate part and the boundary part according to the first embodiment of the invention is sent to a baking furnace and subjected to baking of the multilayer coating film.

In the second embodiment according to the invention, in the working area 4, coating is not carried out, and the white based intermediate paint (1) is coated in the outer plate part of the automobile body having an electrodeposition coating film layer formed thereon by the first-stage coating machine 1.

Subsequently, in the working area 5, the white based color base paint (2) is coated in the inner plate part and the boundary part of the automobile body having an electrodeposition coating film layer formed thereon.

Subsequently, the white based color base paint (2) is coated in the outer plate part of the automobile body by the coating machine 2a of the preceding stage in the second-stage coating machine 2.

Subsequently, the luster material-containing base paint (3) is coated in the outer plate part of the automobile body by the coating machine 2b of the subsequent stage in the second-stage coating machine 2.

Subsequently, in the working area 6, the luster material-containing clear paint (5) is coated in the inner plate part and the boundary part of the automobile body.

Subsequently, the clear paint (4) is coated in the outer plate part of the automobile body by the third-stage coating machine 3.

The automobile body in which the multilayer coating film has been thus formed in the outer plate part, the inner plate part and the boundary part according to the second embodiment of the invention is sent to a baking furnace and subjected to baking of the multilayer coating film.

In the third embodiment according to the invention, in the working area 4, the white based intermediate paint (1) is coated in the inner plate part and the boundary part of the automobile body.

Subsequently, the white based intermediate paint (1) is coated in the outer plate part of the automobile body by the first-stage coating machine 1.

Subsequently, in the working area 5, the white based color base paint (2) is coated in the inner plate part and the boundary part of the automobile body.

Subsequently, the white based color base paint (2) is coated in the outer plate part of the automobile body by the coating machine 2a of the preceding stage in the second-stage coating machine 2.

Subsequently, the luster material-containing base paint (3) is coated in the outer plate part of the automobile body by the coating machine 2b of the subsequent stage in the second-stage coating machine 2.

Subsequently, in the working area 6, the luster material-containing clear paint (5) is coated in the inner plate part and the boundary part of the automobile body.

Subsequently, the clear paint (4) is coated in the outer plate part of the automobile body by the third-stage coating machine 3.

The automobile body in which the multilayer coating film has been thus formed in the outer plate part, the inner plate part and the boundary part according to the third embodiment of the invention is sent to a baking furnace and subjected to baking of the multilayer coating film.

In the light of the above, according to the invention, not only the outer plate part of the automobile body can be coated by a 4-coat 1-bake system by using an existing coating line, but a coating film having an appearance close to an appearance of the coating film of the outer plate part can be formed in the inner plate part and the boundary part of the automobile body by a 2-coat 1-bake system or a 3-coat 1-bake system.

### EXAMPLES

Specific working examples according to the invention are hereunder described. All blending amounts are on a weight basis unless otherwise indicated.

### [Preparation of Aqueous White Based Intermediate Paint (PWC: 45%)]

30 parts of a vinyl-modified polyester resin solution, manufactured by Nippon Paint Co., Ltd. (non-volatile matter content: 40.0%, acid value of solids: 32.5 mg-KOH/g, hydroxyl value: 138, weight average molecular weight: 57,000, rate of neutralization: 90%), 24.5 parts of CR-97 (a trade name of titanium dioxide, manufactured by Ishihara Sangyo Kaisha, Ltd.) and 12 parts of B-34 (a trade name of precipitated barium sulfate, manufactured by Sakai Chemical Industry Co., Ltd.) were mixed and dispersed at room temperature for one hour in a paint conditioner upon addition of a glass bead medium, thereby obtaining a pigment paste for intermediate paint having a particle size of not more than 5 μm. This paste was mixed with 21.8 parts of a water sol S-370 (a trade name of an epoxy-modified polyester resin, manufactured by DIC Corporation, hydroxyl value: 100, acid value: 40, weight average molecular weight: 17,000, solids content: 55%) solution, 4 parts of DENACOL EX-861 (a trade name of an aqueous epoxy resin, manufactured by Nagase ChemteX Corporation, solids content: . . . %), 10 parts of CYMEL 325 (a trade name of a melamine resin, manufactured by Mitsui Cytec Ltd., solids content: 80%), 8 parts of CYMEL 303 (a trade name of a melamine resin, manufactured by Mitsui Cytec Ltd., solids content: 100%) and 44 parts of a crosslinked resin particle (a viscosity modifier, manufactured by Nippon Paint Co., Ltd., solids content: 20%), and the mixture was stirred for mixing for 10 minutes by a disperser, thereby obtaining an aqueous white based intermediate paint.

### [Preparation of Aqueous White Based Color Base Paint (PWC: 40%)]

97.1 parts of an acrylic emulsion, manufactured by Nippon Paint Co., Ltd. (average particle size: 150 nm, non-volatile matter content: 20%, acid value of solids: 20 mg-KOH/g, hydroxyl value: 40 mg-KOH/g), 5 parts of a 10% by mass aqueous solution of dimethyl ethanolamine, 13.1 parts of a water-soluble acrylic resin, manufactured by Nippon Paint Co., Ltd. (non-volatile matter content: 30.0%, acid value of solids: 40 mg-KOH/g, hydroxyl value: 50 mg-KOH/g), 3.5 parts of PRIMEPOL PX-1000 (a bifunctional polyether polyol, manufactured by Sanyo Chemical Industries, Ltd., number average molecular weight: 400, hydroxyl value: 278 mg-KOH/g, primary/secondary hydroxyl value ratio: 63/37, non-volatile matter content: 100%), 10.0 parts of CYMEL 204 (a mixed alkylated melamine resin, manufactured by Mitsui Cytec Ltd., non-volatile matter content: 100%), 0.2 parts of lauryl acid phosphate and 24.5 parts of CR-97 (a trade name of titanium dioxide, manufactured by Ishihara Sangyo Kaisha, Ltd.) were mixed, and the mixture was uniformly dispersed, thereby obtaining an aqueous white based color base paint.

### [Preparation of Aqueous Mica-Containing Base Paint (PWC: 10%)]

285.4 parts of an acrylic emulsion, manufactured by Nippon Paint Co., Ltd. (average particle size: 150 nm, non-volatile matter content: 20%, acid value of solids: 20 mg-KOH/g, hydroxyl value: 40 mg-KOH/g), 15 parts of a 10% by mass aqueous solution of dimethyl ethanolamine, 38.6 parts of a water-soluble acrylic resin, manufactured by Nippon Paint Co., Ltd. (non-volatile matter content: 30.0%, acid value of solids: 40 mg-KOH/g, hydroxyl value: 50 mg-KOH/g), 10.4 parts of PRIMEPOL PX-1000 (a bifunctional polyether polyol, manufactured by Sanyo Chemical Industries, Ltd., number average molecular weight: 400, hydroxyl value: 278 mg-KOH/g, primary/secondary hydroxyl value ratio: 63/37, non-volatile matter content: 100%), 29.4 parts of CYMEL 204 (a mixed alkylated melamine resin, manufactured by Mitsui Cytec Ltd., non-volatile matter content: 100%), 0.3 parts of lauryl acid phosphate and 12.0 parts of a mica flake pigment “IRIODIN 103W2” (manufactured by Merck Chemicals) were mixed, and the mixture was uniformly dispersed, thereby obtaining an aqueous mica-containing base paint.

### [Clear Paint]

“MACFLOW O-1820 CLEAR” (a trade name of an acid/epoxy hardening type clear paint, manufactured by Nippon Paint Co., Ltd.) was used as a clear paint.

### [Preparation of Mica-Containing Clear Paint (PWC: 0.5%)]

To 100 parts of “MACFLOW 0-1820 CLEAR” (a trade name of an acid/epoxy hardening type clear paint, manufactured by Nippon Paint Co., Ltd.) as a clear paint, 0.25 parts of a mica flake pigment “IRIODIN 103W2” (manufactured by Merck Chemicals) was added, and the mixture was uniformly dispersed, thereby obtaining an aqueous mica-containing clear paint.

### Examples 1 to 3 and Comparative Examples 1 to 4

A multilayer coating film to be formed in an inner plate part and a boundary part of an automobile body was formed on a substrate by using the above-prepared respective paints, thereby preparing a coated plate.

### Example 1

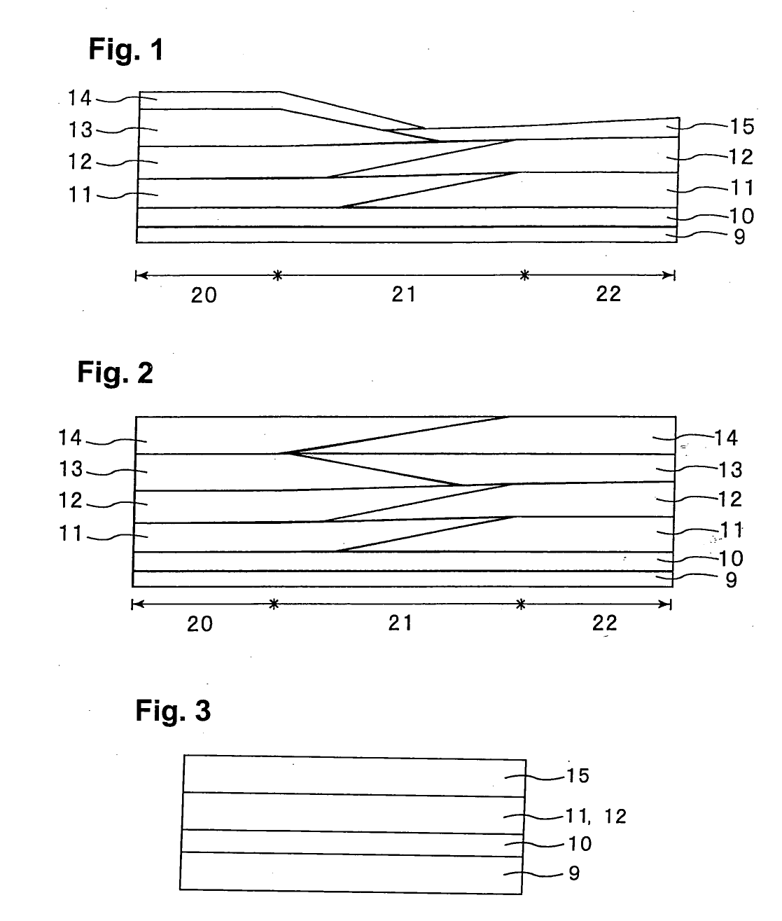

The following steps were carried out while supposing an inner plate part of an automobile body so as to have a lamination order shown in FIG. 1.

A dull steel plate having a size of 30 cm×40 cm and a thickness of 0.8 mm was treated with zinc phosphate, and thereafter, an electrodeposition coating film layer was formed thereon by using a cationic electrodeposition paint “POWER TOP V-6” (manufactured by Nippon Paint Co., Ltd.), thereby preparing a substrate.

On the foregoing substrate having an electrodeposition coating film layer formed thereon, the foregoing aqueous white based intermediate paint was spray coated in a dry film thickness of 20 set for one minute and then preheated at 80° C. for 3 minutes.

Subsequently, the foregoing aqueous white based color base paint was spray coated on the white based intermediate coating film in a dry film thickness of 8 μm. After spray coating, the resulting coating film was set for one minute and then preheated at 80° C. for 3 minutes.

Subsequently, the foregoing mica-containing clear paint was spray coated in a dry film thickness of 20 μm on the white based color base coating film. After coating, the resulting coating film was set for 7 minutes, and the obtained coated plate was baked at 140° C. for 20 minutes by a drying machine.

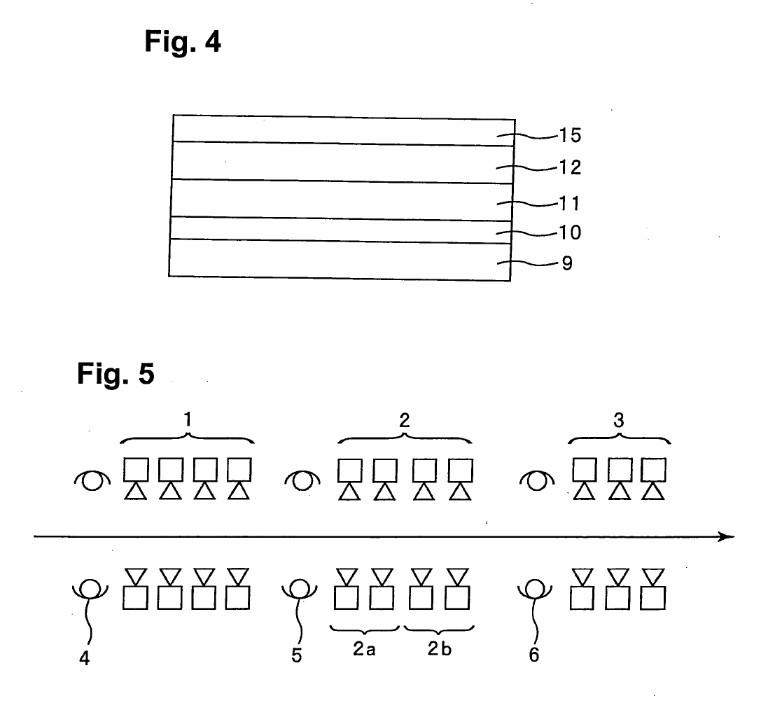

There was thus obtained a multilayer coating film shown in FIG. 4.

### Example 2

Coating was carried out in the same manner as in Example 1, except that after coating the white based intermediate paint, the mica-containing clear paint was coated without coating the white based color base paint. There was thus obtained a multilayer coating film shown in FIG. 3.

### Example 3

Coating was carried out in the same manner as in Example 1, except that the white based color base paint was coated and further, the mica-containing clear paint was coated on the substrate having an electrodeposition coating film layer formed thereon without coating the white based intermediate paint. There was thus obtained a multilayer coating film shown in FIG. 3.

### Comparative Example 1

The following steps were carried out while supposing an inner plate part of an automobile body so as to have a lamination order shown in FIG. 2.

After coating the white based color base paint, the foregoing aqueous mica-containing base paint was coated in a dry film thickness of 7 μm. After coating, the coated paint was set for one minute and then preheated at 80° C. for 3 minutes. Subsequently, the foregoing clear paint was coated in a dry film thickness of 20 μm and set for 7 minutes.

A coated plate was prepared in the same manner as in Example 1, except for the foregoing.

### Comparative Example 2

A coated plate was prepared in the same manner as in Comparative Example 1, except that the clear paint was not coated.

### Comparative Example 3

A coated plate was prepared in the same manner as in Comparative Example 1, except that after coating the white color base paint, the clear paint was coated without coating the mica-containing base paint.

### Comparative Example 4

A coated plate was prepared in the same manner as in Comparative Example 1, except that after coating the white based intermediate paint, the clear paint was coated without coating the white based color base paint and the mica-containing based paint.

FIG. 3 is a sectional view showing the multilayer coating film formed according to the first embodiment and second embodiment of the invention and shows the multilayer coating film of Examples 2 and 3.

As shown in FIG. 3, an electrodeposition coating film layer 10 is formed on a substrate 9; a white based intermediate coating film 11 or a white based color base coating film 12 is formed on the electrodeposition coating film layer 10; and a luster material-containing clear coating film 15 is formed thereon.

FIG. 4 is a sectional view showing the multilayer coating film of the third embodiment according to the invention and shows the multilayer coating film of Example 1.

As shown in FIG. 4, the electrodeposition coating film layer 10 is formed on the substrate 9; the white based intermediate coating film 11 is formed on the electrodeposition coating film layer 10; the white based color base coating film 12 is formed on the white based intermediate coating film 11; and the luster material-containing clear coating film 15 is formed on the white based color base coating film 12.

### Evaluation of coated plates of Examples 1 to 3 and Comparative Examples 1 to 4

The coated plates of Examples 1 to 3 and Comparative Examples 1 to 4 were evaluated with respect to “man-hour”, “sag/lack of hiding”, “finished appearance” and “hue” according to the following determination criteria.

Man-Hour:

A: The man-hour is small, and such is favorable.

AB: The man-hour is tolerable from the standpoint of the line process.

C: The man-hour is hardly tolerable in from the standpoint of the line process.

Sag/Lack of Hiding:

A: The sag/lack of hiding is hardly caused, and such is favorable from the working standpoint.

B: The sag/lack of hiding is easily caused, and attention must be taken from the working standpoint.

Finished Appearance:

A: The visual appearance is very good.

AB: The visual appearance is good.

C: The coated plate is lusterless, its skin is poor, and its appearance is very poor.

Hue:

A: The hue is exactly the same as that in the outer plate part, and such is favorable.

AB: The hue is free from an uncomfortable feeling among the inner plate part, the outer plate part and the boundary part, and such is tolerable.

C: No luster feeling is revealed, and the hue is quite different between the inner plate part and the outer plate part.

The thus obtained evaluation results are shown in the following Table 1.

TABLE 1

| No. | | Ex. 1 | Ex. 2 | Ex. 3 | Comp. Ex. 1 | Comp. Ex. 2 | Comp. Ex. 3 | Comp. Ex. 4 |
|---|---|---|---|---|---|---|---|---|
| 1 | White Based | Yes | Yes | No | Yes | Yes | Yes | Yes |
| | Intermediate Paint | | | | | | | |
| 2 | White Based | Yes | No | Yes | Yes | Yes | Yes | No |
| | Color Base Paint | | | | | | | |
| 3 | Mica-containing | No | No | No | Yes | Yes | No | No |
| | Base Paint | | | | | | | |
| 4 | Mica-containing | Yes | Yes | Yes | No | No | No | No |
| | Clear Paint | | | | | | | |
| 5 | Clear Paint | No | No | No | Yes | No | Yes | Yes |

| | | | | | | | |
|---|---|---|---|---|---|---|---|
| Man-hour | AB | A | A | C | AB | AB | A |
| Sag/lack of Hiding | A | A | A | B | B | A | A |
| Finished Appearance | AB | AB | AB | A | C | A | A |
| Hue | AB | AB | AB | A | A | C | C |

Comparative Example 1 has the same multilayer coating film as that in an outer plate part of an automobile body, and in the case where such a multilayer coating film is prepared in three working areas, two coating steps must be carried out in a single working area, and therefore, the process is complicated. Also, coating is carried out twice in a single working area, and therefore, sag/lack of hiding is easily caused in the coating film.

In Comparative Example 2, the clear coating film layer is not formed on the surface, and therefore, the coated plate is poor in the luster and remarkably deteriorated in the finished appearance.

In Comparative Examples 3 and 4, the mica pigment which is a luster pigment is not incorporated into the multilayer coating film, and therefore, the coated plate is remarkably different in the hue from the outer plate part.

On the other hand, in Examples 1 to 3, coating can be carried out in the inner plate part and the boundary part in three areas or two areas. Also, in the finished appearance and hue, the coating film substantially close to the multilayer coating film of the outer plate part can be formed.

FIG. 1 is a schematic sectional view showing the state of a multilayer coating film in an outer plate part 20, a boundary part 21 and an inner plate part 22 in case of forming the multilayer coating film of Example 1 in the inner plate part.

As shown in FIG. 1, the electrodeposition coating film layer 10 is formed on the substrate 9. In the outer plate part 20, the white based intermediate coating film 11, the white based color base coating film 12, the luster material-containing base coating film 13 and the clear Coating film 14 are multilayer on the electrodeposition coating film layer 10.

In the boundary part 21 and the inner plate part 22, the white based intermediate coating film 11 and the white based color base coating film 12 are formed on the electrodeposition coating film layer 10, and the luster material-containing clear coating film 15 is formed on the white based color base coating film 12. The white based intermediate coating film 11 in the boundary part 21 and the inner plate part 22 is formed prior to forming the intermediate coating film 11 in the outer plate part. Also, the white based color base coating film 12 of the boundary part 21 and the inner plate part 22 is formed prior to forming the white based color base coating film 12 in the outer plate part. Also, the luster material-containing clear coating film 15 in the boundary part 21 and the inner plate part 22 is formed prior to forming the clear coating film 14 in the outer plate part 20.

FIG. 2 is a schematic sectional view showing the state of a multilayer coating film in the outer plate part 20, the boundary part 21 and the inner plate part 22 incase of forming the multilayer coating film of Comparative Example 1 in the boundary part 21 and the inner plate part 22.

As shown in FIG. 2, in the boundary part 21 and the inner plate part 22, the luster material-containing base coating film 13 and the clear coating film 14 must be formed, and therefore, after forming the luster material-containing base coating film 13 in the outer plate part 20 and prior to forming the clear coating film 14, the luster material-containing base coating film 13 and the clear coating film 14 are superimposed and formed in the boundary part 21 and the inner plate part 22.

In the case where two kinds of paints are thus superimposed and coated in the boundary part 21 and the inner plate part 22, a space of the working environment is limited, and therefore, it is difficult to form a thoroughly uniform coating film.

On the other hand, in the invention, a single paint may be coated in a single area for coating the boundary part and the inner plate part, and therefore, not only a process of working can be simplified, but a uniform coating film can be formed.

What is claimed is:

1. A coating method of an automobile body for forming a multilayer coating film on an electrodeposition coating film layer of an outer plate part, an inner plate part and a boundary part between the inner plate part and the outer plate part of an automobile body, the method comprising:
coating an outer plate part of an automobile body by a 4-coat 1-bake system including coating a white based intermediate paint (1) with from N7 to N9.5 on an electrodeposition coating film layer, coating a white based color base paint (2) with from N7 to N9.5 thereon by a wet-on-wet technique, coating a luster material-containing base paint (3) containing a luster pigment thereon by a wet-on-wet technique, further coating a clear paint (4) thereon by a wet-on-wet technique, and then baking for hardening a first multilayer coating film in the outer plate part of the automobile body; and
carrying out at least one step of steps (A) and (B) and thereafter carrying out a step (C) with respect to an inner plate part and a boundary part of the automobile body,
the step (A) including coating the white based intermediate paint (1) in the inner plate part and the boundary part of the automobile body, prior to coating the white based intermediate paint (1) in the outer plate part of the automobile body,
the step (B) including coating the white based color base paint (2) in the inner plate part and the boundary part of the automobile body, prior to coating the white based color base paint (2) in the outer plate part of the automobile body, and
the step (C) including coating a luster material-containing clear paint (5) corresponding to a paint containing said luster pigment dispersed in the clear paint (4) in the inner plate part and the boundary part of the automobile body, prior to coating the clear paint (4) in the outer plate part of the automobile body;
wherein a second multilayer coating film in the inner plate part and the boundary part of the automobile body is baked simultaneously with baking of said first multilayer coating film in the outer part of the automobile body.

2. The coating method of an automobile body according to claim 1, wherein after the step (A), the step (C) is carried out so that the second multilayer coating film in the inner plate part and the boundary part of the automobile body is formed from the white based intermediate paint (1) and the luster material-containing clear paint (5).

3. The coating method of an automobile body according to claim 1, wherein after the step (B), the step (C) is carried out so that the second multilayer coating film in the inner plate part and the boundary part of the automobile body is formed from the white based color base paint (2) and the luster material-containing clear paint (5).

4. The coating method of an automobile body according to claim 1, wherein after the steps (A) and (B), the step (C) is carried out so that the second multilayer coating film in the inner plate part and the boundary part of the automobile body from the white based intermediate paint (1), the white based color base paint (2) and the luster material-containing clear paint (5).

5. The coating method of an automobile body according to claim 1, wherein the luster pigment is at least one material selected from a group consisting of a mica powder, an alumina powder and a silica powder.

6. An automobile body coated by the method according to claim 1.

7. The coating method of an automobile body according to claim 2, wherein the luster pigment is at least one material selected from a group consisting of a mica powder, an alumina powder and a silica powder.

8. An automobile body coated by the method according to claim 2.

9. The coating method of an automobile body according to claim 3, wherein the luster pigment is at least one material selected from a group consisting of a mica powder, an alumina powder and a silica powder.

10. An automobile body coated by the method according to claim 3.

11. The coating method of an automobile body according to claim 4, wherein the luster pigment is at least one material selected from a group consisting of a mica powder, an alumina powder and a silica powder.

12. An automobile body coated by the method according to claim 4.
